(19) United States
(12) Patent Application Publication
(10) Pub. No.: US 2006/0243677 A1
(43) Pub. Date: Nov. 2, 2006

(54) Manure separator

(76) Inventor: Donald T. Sheahan, Reedsville, WI (US)

Correspondence Address: RYAN KROMHOLZ & MANION, S.C., POST OFFICE BOX 26618, MILWAUKEE, WI, 53226, US

(21) Appl. No.: 11/115,537

(22) Filed: Apr. 27, 2005

(51) Int. Cl. C02F 11/12; B01D 21/00; B01D 36/04

(52) U.S. Cl. 210/800; 210/804; 210/806; 210/221.2; 210/703; 210/380.3; 210/360.1

(57) ABSTRACT

An apparatus and system for separating manure and sand in animal bedding is disclosed. The system separates the manure and sand by using a separator filled with water that agitates the sand/manure mixture with air and water. The manure removed from the separator is further processed to remove excess water from the manure. A spinning or centrifugal device is used to remove excess water from the manure.

### BACKGROUND OF THE INVENTION

The following invention is related to manure disposal for farms, and specifically to machines that separate manure/sand mixtures for hauling and storage purposes. More specifically, the present invention relates to separators for separating or removing sand and water from manure.

Many dairy farmers use sand as bedding for stalls within a barn. While the sand provides comfort for the cows, it is a problem within manure pits and, also, a problem when hauling away the manure. The sand in the manure adds unneeded weight to the manure, directly and indirectly with extra water being retained in the mix, which unnecessarily compacts soil when the manure is used as a fertilizer. Also, the manure/sand mix is more of a pollutant to the environment than manure itself.

Machines have been designed to separate sand from the manure solids. An example of such a device can be found in Wedel, U.S. Pat. No. 5,950,839. The device uses water and air in combination to agitate the bedding, which allows the sand to settle out from the water and manure solids. The manure solids and water mixture is then skimmed off and removed. However, the manure solids and water still are combined, which results in the same problems of compacted manure. The compacted manure results in a lower yield in the crops to which the manure is applied. Furthermore, the weight of the water in the manure makes the manure more difficult to haul and transport. Storage of the wet manure is also a problem, as the water in the manure leads to an increase in the amount of bacteria and decreases the usefulness of the manure.

It is also desired for the overall process of cleaning the manure to be more effective. That is, the process of removing the sand bedding from the stall and separating the bedding into reusable sand and manure may be more efficiently done than current practices. For instance, the feeding process of the unprocessed bedding into the water/air separator could be further streamlined and automated. Likewise, the water/air separator could also be improved to provide a more efficient separator. These and other shortcomings of the prior art are contemplated by the present invention.

### SUMMARY OF THE INVENTION

The present invention minimizes these problems. Water and air are used together to remove the sand from manure. A first separator or container having means for agitating the water and air will efficiently break up manure entering into the device. The device allows sand to drop to the bottom of the container quickly, which allows the manure solids to float to the surface of the container and to be removed. A second separator containing a spinning device or container will then use centrifugal force to separate the water and the manure solids removed from the first separator. The separation of the water from the separated manure provides for a more useable manure and, also, an easier to haul product. Furthermore, this is beneficial in not only reducing the weight of the manure, but, also, in removing more bacteria and similar unwanted organisms from the manure than in previous separator designs.

### BRIEF DESCRIPTION OF THE DRAWINGS

FIG. 1 is a diagrammatic overview of the manure separating process of the present invention.

FIG. 2 is a perspective view of a system for separating manure according to the present invention.

FIG. 3 is a partially cut-away perspective view of a separating device for separating manure from sand in accordance with the present invention.

FIG. 4 is a sectional view of the separating device of FIG. 3 taken along line 4-4 of FIG. 3.

FIG. 4A is a sectional view of the separating device of FIG. 3 taken along line 4A-4A of FIG. 3.

FIG. 5 is an overhead view of the device shown in FIG. 4 taken along line 5-5.

FIG. 6 is a partially cut-away perspective view of a separating device for separating manure from water in accordance to the present invention.

FIG. 7 is a sectional view of the device shown in FIG. 6 taken along line 7-7 of FIG. 6.

FIG. 8 is a partially cut-away side plan view of the device shown in FIG. 6.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

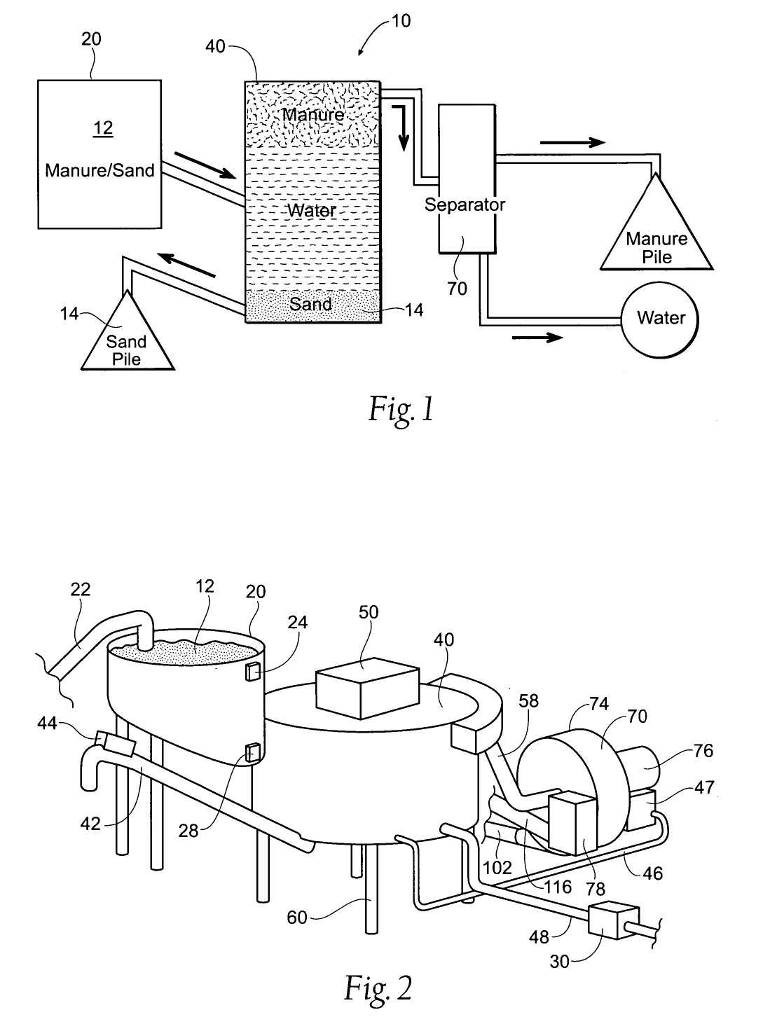

FIG. 1 shows a diagrammatic representation of a manure separating system 10 according to the present invention. The system 10 comprises a holding tank 20 for storing manure 12, a separator 40 for removing sand 14 and solids from the manure 12, and a second separator 70 for removing excess water from the manure 12. The system 10 allows for sand 14 to be recycled and used again as bedding for livestock and, also, the system 10 allows for the manure 12 to be used as an efficient future fertilizer. Because the system 10 provides for drier resultant manure than previous methods and apparatuses, the manure is a more effective fertilizer, since it will not be as compacted when it is stored, hauled, or applied to crops. Also, the manure will contain fewer bacteria since the water content of the manure is less, which provides less breeding area for the bacteria.

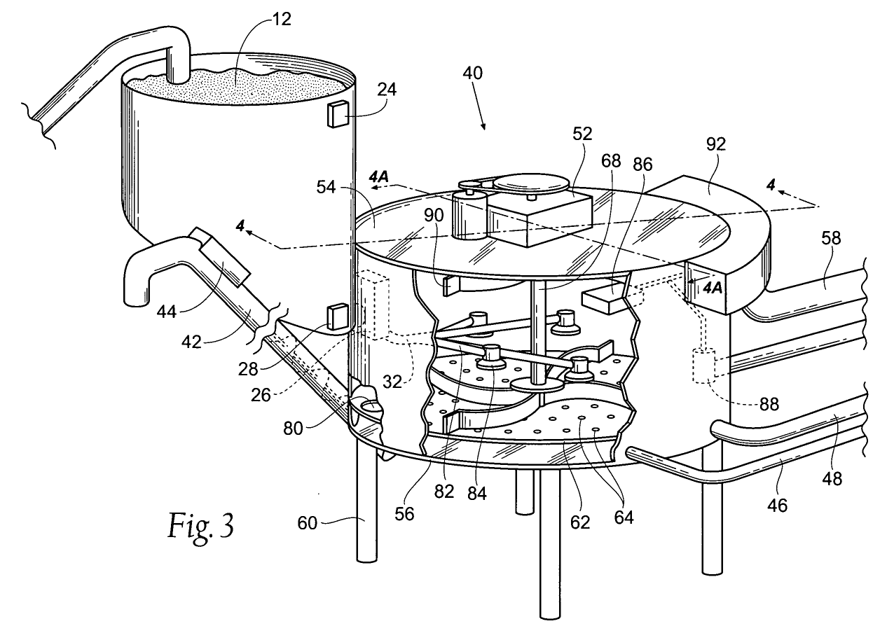

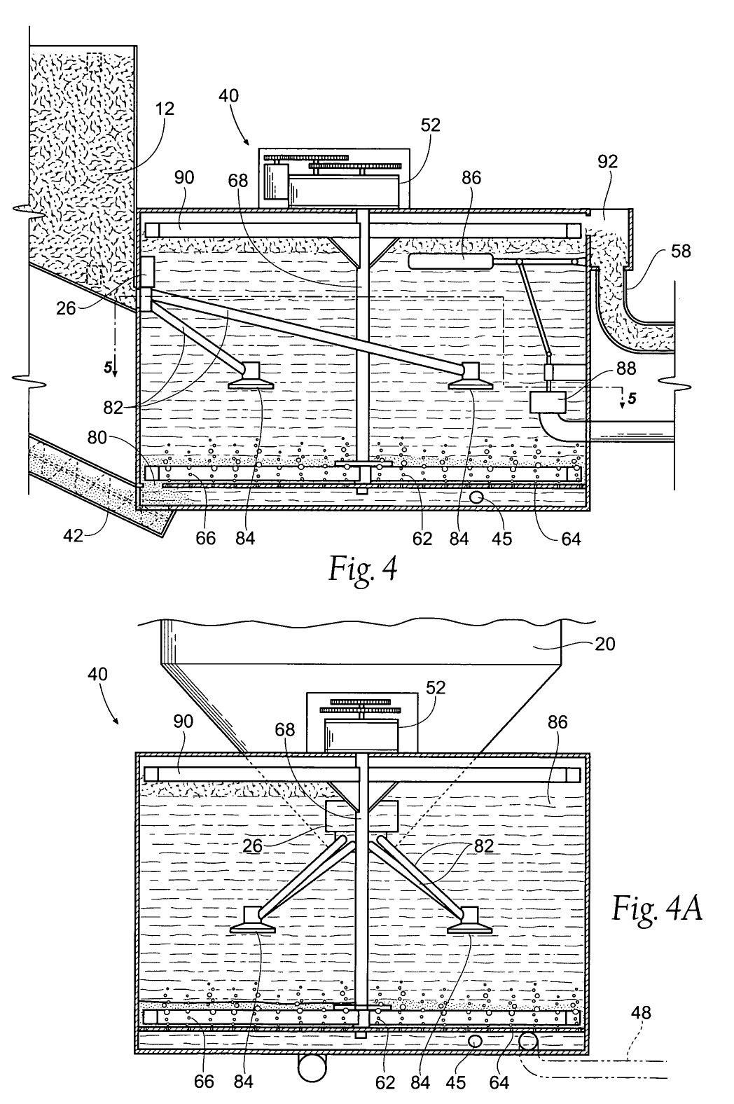

FIG. 2 is a perspective view of an embodiment of the system 10. Once the manure 12 is scraped from the livestock stalls (not shown), an auger or conveyor 22 carries the manure 12 into the holding tank 20. It is understood that a pump or other carrying means, such as a tractor or a front-end loader, could also be used in place of the auger 22. The tank 20 may have a start switch 24 to turn on the separator 40 when the holding tank 20 fills up with manure 12. The start switch 24 may also open up a gate valve 26 (see FIG. 4A) that will allow the manure 12 to exit the tank 20 and proceed towards the separator 40. The gate valve 26 is preferably a sliding door that may be controlled by hydraulic means. The start switch 24 may also turn on a water pump 30 that will pump water into the separator 40. While it may be possible to have separate switches for each of these operations, using a single switch is advantageous to insure that each of these functions works concurrently with the other functions. For example, using a single switch or device prevents the manure 12 from piling up within the separator 40 when there is no water within the separator 40. A second switch 28 may be used to stop the separator 40, close the gate valve 26, and turn off the water pump 30. It may be possible to use other automatic or manual means for opening and closing the gate valve 26 and turning the separator 40 on and off. Additionally, the gate valve 26 may be of any dimensions or size that will allow the manure 12 to travel from the holding tank 20 to the separator 40. Similarly to having the start switch 24 control different functions so that different functions start concurrently, it is advantageous to have the second switch 28 turn off various functions concurrently. Override switches may be used on the tank 20, as well. The gate valve 26 will be connected to a tube or other passageway 32, which will be discussed in further detail with respect to FIGS. 3-5. The holding tank 20 may be elevated with respect to the separator 40 to take advantage of gravity when moving the manure 12 into the separator 40.

Still referring to FIG. 2, once the manure 12 enters the separator 40, it will be separated, so that the sand 14 embedded within the manure 12 will filter out of the manure 12. The manure 12 will break up when it becomes agitated, which allows the sand 14 to separate and settle from the manure 12. The agitation will be discussed further with respect to FIGS. 3-5. Because the sand is heavier than the water and manure 12, the sand 14 will precipitate to the bottom of the separator 40. The sand 14 will be removed from the separator 40 and transported away by an auger or conveyor 42. The auger 42 may pass through a wash area 44, which may take the form of a shower or spray system, that will further wash the sand 14. The wash area 44 is preferably located at a height above the height of the level of the water within the separator 40, so that the water will drain downwardly into the separator 40. The sand 14 will then proceed to a sand pile, where it may be recycled and used again as bedding. As shown in FIG. 2, each container further downstream of the system 10 is preferably at a lower elevation than the previous container. That is, the holding tank 20 is elevated with respect to the first separator 40, which is elevated with respect to the second separator 70. This allows gravity to assist in moving the manure through the stream, which allows for less extra force or power required for operation of the system 10.

FIG. 3 shows a partially cut-away perspective view of the separator 40. The separator 40 uses water and air in combination to agitate the incoming manure 12. An air intake 45 (see FIG. 4) is connected to an air intake line 46, which is driven by an air compressor 47 (see FIG. 2) to thereby provide the needed air force or pressure for the agitation process. Water will be supplied by a water supply line 48 (see FIG. 2). Agitation of the manure 12 works together with a gear reducer 52, which controls the various scraping devices of the separator 40. The gear reducer 52 is located within a housing 50 (see FIG. 2) to protect the individual parts of the gear reducer 52 from dirt and debris of the surrounding environment.

Still referring to FIG. 3, the separator 40 has a top side 54 and a bottom side 56. Because the manure 12 will be lighter than the water within the separator 14 once the sand 14 is removed from the manure 12, an exit 58 for the manure 12 is located near the top side 54. The bottom side 56 of the separator 40 may be supported by legs or supports 60, which elevate the first separator 40 above the second separator 70, thereby allowing gravity to assist in moving the manure 12 from the first separator 40 to the second separator 70 (see FIG. 2). However, the second separator 70 may be situated at the same elevation as that of where the removed manure and water exit the first separator 40 through the exit 58. A floor 62 containing a plurality of apertures 64 is located above the bottom side 56. The floor 62 and the bottom side 56 should be sufficiently spaced apart, with a space around 6″ being approximately a preferred height between the two. The apertures 64 allow air and water to enter the separator 40, thereby providing the necessary agitation of the manure 12. The apertures 64 are preferably evenly spaced and of a sufficient size to allow air and water to be pumped into the separator 40. One example of an adequately sized aperture 64 would have a diameter of ½″. However, any sizing and spacing of apertures that will not hinder the agitation process will fall within the scope of the present invention.

Referring further to FIG. 3, within the separator 40, a plurality of scraper paddles 66 are used to remove the settling sand 14 from the separator 40. The paddles 66 are connected to a drive shaft 68 that is connected to the gear reducer 52. As the gear reducer 52 turns the paddles 66, the sand 12 will be force towards a sand exit 80, where it will be removed from the separator 40 by an auger 42, as previously discussed. The paddles 66 may turn at any speed, but a slower speed is preferred, such as 3 rpm, to prevent the settling sand from being agitated again.

FIGS. 4 and 4A shows sectional views of the separator 40 taken along line 4-4 and 4A-4A of FIG. 3, respectively. The separator 40 is shown filled with water and manure. The manure 12 comes in from the holding tank 20 through the gate valve 26, discussed previously. The gate valve 26, which preferably allows manure 12 to enter the separator 40 by gravitational means, will be designed to shut off before the separator 40 is turned off so that the separator 40 will not overflow. It should be understood that other liquids besides water may be used in the system and the system will still fall within the scope of the present invention. Reference to water should be understood to include other suitable liquids. Along the floor 62, the incoming air is indicated with air bubbles. Furthermore, the air will enter into the separator 40 preferably mixed with the incoming water stream. The separator 40 will be filled to a predetermined height, depending on the dimensions of the separator and the user's preferences. The air mixes with the manure 12 that comes in through a plurality of distribution tubes 82, with each having a dispersion exit 84. The arrangement of the tubes 82 allows even dispersion of the manure 12 throughout the separator 40, thereby making the overall separation process more efficient. To keep the water level consistent within the separator 40, a float 86 and valve assembly 88 is used. If the water level becomes to low, the float 86 will trigger the valve assembly 88, thereby allowing more water to enter the separator 40 from the water intake 48. If the water level is too high, the water will drain from the separator through the manure exit 58.

Still referring to FIGS. 4 and 4A, a skimmer 90 is located above the float 86 to remove the separated manure 12 from the separator 40. The skimmer 90 may also be connected to the shaft 68 and be driven by way of the gear reducer 52. As the manure 12 floats on the top level of the water, the skimmer 90 will move the manure towards an overflow section or trough 92, where the manure 12 may then proceed into the manure exit 58 and into the second separator 70. The manure 12 will contain a residual amount of water after exiting the first separator 40. The trough 92 is preferably elevated with respect to the second separator 70 so that gravity will assist in the manure 12 removal. The trough 92 preferably circles about ¼ of the perimeter of the separator 40 and is located a small distance above the water level within the separator 40. Overall, the separator 40 should have enough depth so that the sand removal and manure removal processes do not interfere with one another. Likewise, the predetermined height of the water or other liquid in the separator 40 should be sufficient so that the agitation process will be adequately carried out.

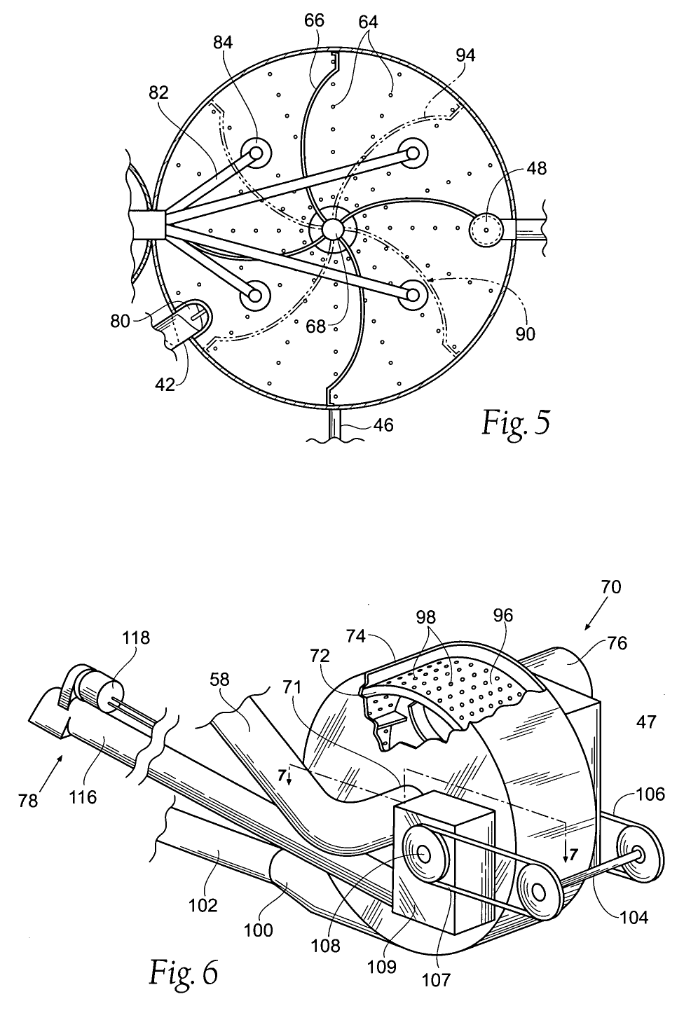

FIG. 5 shows a cut-away view of the separator 40 taken along line 5-5 of FIG. 3. The distribution tubes 82 are arranged so that manure 12 will enter evenly into the separator 40, preferably with manure 12 entering into each quadrant of the separator 40. The tubes 82 terminate in the dispersion exits 84, which are arranged so as not to interfere with the scraper paddles 66 or the skimmer 90 (shown in phantom). Preferably, the exits 84 are positioned generally centrally within the separator 40 (see FIG. 4) to further provide even distribution of the manure 12 within the separator 40. The separator 40 is preferably cylindrical in shape, which allows the scraper paddles 66 and the skimmer 90 to cover the entire cross-sectional area of the separator 40. However, the present invention also encompasses other shaped separators. Further, the tubes 82 are located preferably centrally between the top side 54 and the bottom side 56, which further assists the separation process by allowing the incoming manure/sand mixture have enough area on all sides for agitation to occur. Together, with the gravitationally assisted feed for the tubes 82, the present invention reduces the necessary power needed for the separator 40.

Still referring to FIG. 5, the scraper paddles 66 and a plurality of scraper blades 94 (shown in phantom) that comprise the skimmer 90 preferably have a curved shape, with the ends of the paddles 66 and the blades 94 being flat-edged. This arrangement helps in moving sand 14 towards the sand exit 80 and manure towards the manure exit 48, respectively. The paddles 66 and the blades 94 may or may not be aligned with each other. Likewise, the paddles 66 and the blades 94 are preferably both driven off of the drive shaft 68 to minimize the number of moving parts needed for the device.

FIG. 6 shows a partially cut-away perspective view of the second separator 70. Now that the sand has been separated from the manure, the second separator 70 will be used to remove excess water from the manure. An outlet 71 attached to the end of the manure/water exit 58 deposits the manure, which was skimmed off from the separator 40, into the second separator 70. Preferably, the distance from the exit 58 to the second separator 70 is a short as possible. This will limit the distance that the manure solids need to travel when entering the separator 70, which may further reduce the size of the building or structure that will house the system 10. This is beneficial, especially when using the system 10 in winter months, when it is necessary to provide insulation to insure that the solids do not freeze up in the piping in the system. The separator 70 has an inner shell 72 and an outer shell 74, with the manure being deposited within the inner shell 72. The inner shell 72 is rotatable and arranged to spin around a central axis, with the power provided by a motor 76. The centrifugal force created by the spinning of the inner shell 72 helps separate the manure from the water. The inner shell 72 should be designed so that it may spin at relatively high speeds, preferably designed so that the shell 72 may spin at speeds up to at least 1000 rpm. This will insure a sufficient portion of the liquid within the entering manure will be removed with the centrifugal process. However, the speed that the shell 72 spins at can be determined by the preferences of the user and how much liquid content the user wishes to remove or retain in the final reduced liquid manure product. The inner shell 72 generally comprises a screen 96 having a plurality of apertures 98. As the inner shell 72 spins or rotates, the water/manure mixture is forced towards the inner shell 72 and the screen 96. It should be understood that the inner shell 72 and the screen 96 may be designed as a single structure or each may be designed separately, and either of these structures or arrangements will fall within the scope of the present invention. The screen 96 will prevent further outward movement of the manure. However, the apertures 98 are arranged so that the water will exit the inner shell 72 through the apertures 98 into the outer shell 74. As the water passes through the apertures towards the outer shell 74, the water will fall towards a basin 100 that is connected to the outer shell 74. The basin 100 has a funnel shape and is further connected to an exit 102 for the water to exit the separator 70. The water may then be recirculated into the system 10 and possibly reused in the separator 40, or pumped away to an irrigation system.

Still referring to FIG. 6, the motor 76 is connected to a shaft 104, such as a jackshaft, by a pulley system 106. The shaft 104 is connected to a second pulley 107, which is connected to an auger shaft 108. The auger shaft 108 is connected to a first auger 109. As the motor 76 rotates the pulley system 106, the shaft 104 rotates and turns the pulley 107, thereby turning the auger shaft 108 and the first auger 109. The first auger 109 may be turned at high speeds, preferably up to at least 1000 rpm, to insure that the liquid reduced manure travels on the auger 109 and out of the separator 70. This provides sufficient means for removing manure from the separator 70 and the inner shell 72.

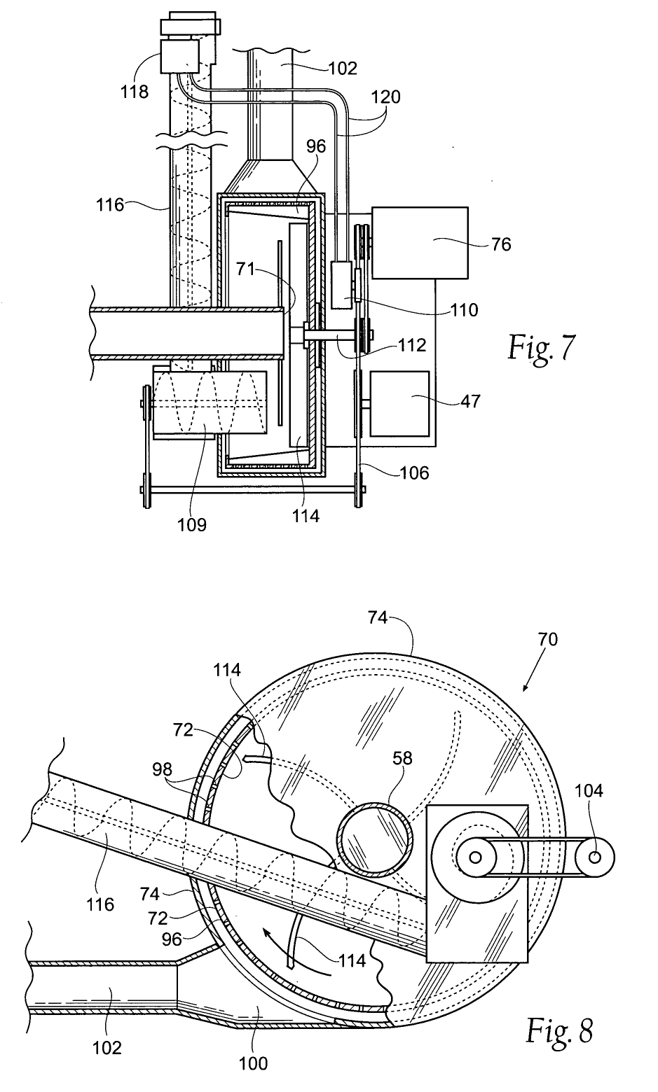

FIG. 7 is a sectional view of the second separator 70 taken along line 7-7 of FIG. 6. FIG. 7 further depicts the manure removal means for the separator 70. The motor 76 and the air compressor 47 are further connected to a hydraulic pump 110 by the pulley system 106. The pulley system 106 is also connected to a central shaft 112, which is connected to a plurality of pump fins 114 (see FIG. 8). As the pulley system 106 rotates the central shaft 112, the pump fins 114 assist in moving the manure entering from the outlet 71 outwardly towards the screen 96. As the manure fills up within the inner shell 72, the pump fins 114 also assist in moving the manure towards the first auger 109. The manure will travel up the first auger 109 and be deposited onto a second auger 116, which will carry the manure away from the separator 70. The second auger 116 preferably is driven by a hydraulic motor 118, which is connected to the hydraulic pump 110 by fluid lines 120. Of course, it is understood that any other suitable power means could be used for the second auger 116 and the other moving components of the separator 70. Likewise the augers 109 and 116 may have other dimensions and arrangements from what is shown, and may further encompass different removal means for the present invention and still fall within the scope of the present invention.

FIG. 8 is a partially cut-away side plan view of the second separator 70. The view of FIG. 8 further depicts the separation process of the separator 70. As shown, the inner shell 72 and the outer shell 74 preferably are arranged in a concentric fashion. While such an arrangement is not necessary, nor is it necessary that the shells 72 and 74 are circular or cylindrical in shape, the arrangement provides for even distribution of the manure within the separator 70, which increases the efficiency of the water removal process. The pump fins 114 preferably are arranged symmetrically, thereby evenly moving and distributing the manure within the inner shell, and further contributing to the efficiency of the separator 70. The design provides a simple but efficient system for allowing the manure to exit along the second auger 116 and for allowing water to drain out of the water exit 102. The drained water may be recycled into the system 10 or possibly pumped away for use in an irrigation system (not shown).

The result of the process is that the final manure product has a significantly lower moisture or liquid content than previous separation processes. While the process does not remove 100% of the water or liquid within the manure, the process does remove a significant amount that noticeably reduces the weight of the manure. Not only does this result in less soil compaction on fields and crops, as previously discussed, the current process also allows for lengthier storage times without bacteria growth and the like forming in the manure. Thus, manure that was separated in the fall and winter could be stored and still be usable as fertilizer in the spring.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An apparatus for reducing the liquid content from a liquid/manure product, said apparatus comprising:
a rotatable inner shell forming a container, said container arranged to receive said liquid/manure product;
a plurality of apertures located on said inner shell, said apertures allowing passage of liquid through said inner shell while retaining manure within said inner shell;
means for rotating said inner shell; and
means for removing said reduced liquid content manure from said inner shell.

2. The apparatus according to claim 1 further comprising an outer shell having a liquid outlet, said inner shell located within said outer shell.

3. The apparatus according to claim 2 wherein said inner shell and said outer shell are cylindrical.

4. The apparatus according to claim 1 further comprising an inlet for receiving said liquid/manure product, said inlet located within said container.

5. The apparatus according to claim 4 further comprising means for moving said liquid/manure product from said inlet towards said inner shell.

6. A process for separating manure and sand in a manure and sand mixture wherein the sand has been used as a bedding for an animal that produces the manure, the process comprising the steps of:
providing a first separator having a top side and a bottom side;
filling said separator with a predetermined level of liquid;
depositing said manure and sand mixture into said first separator;
agitating said manure and sand mixture in said liquid within said first separator to separate said sand and said manure;
removing said manure from said first separator, said manure containing a residual amount of liquid;
providing a second separator, said second separator including a rotatable container;
depositing said removed manure into said rotatable container;
rotating said rotatable container to provide a centrifugal force sufficient to remove a portion of said residual amount of liquid from said removed manure contained in said container.
removing manure from said second separator, said manure having a reduced liquid content.

7. The process according to claim 6 further comprising the steps of:
removing said separated sand from said first separator; and
washing said removed sand.

8. The process according to claim 6, wherein said step of depositing said manure and sand mixture into said first separator is done by gravitational means.

9. The process according to claim 6 wherein said step of depositing said manure and sand mixture further comprises depositing said and manure mixture approximately equidistant between said top side and said bottom side of said first separator.

10. The process according to claim 6 further comprising the step of draining said removed liquid from said second separator.

11. A process for removing liquid from a liquid/manure mixture, said process comprising:
providing a separator having an inner shell, said inner shell having a plurality of apertures;
depositing said liquid/manure mixture into said inner shell;
spinning said inner shell, thereby centrifugally forcing said liquid/manure towards said apertures;
retaining said manure within said inner shell while allowing said liquid to pass through said apertures, thereby forming a reduced liquid manure product; and
removing said reduced liquid manure product from separator.

12. The process according to claim 11 wherein said separator further comprises an outer shell, said inner shell being located within said outer shell, said process further comprising the step of retaining said liquid passing through said apertures with said outer shell.

13. The process according to claim 12 further comprising the step of draining said retained liquid.
